(19) United States
(12) Patent Application Publication
(10) Pub. No.: US 2017/0181565 A1
(43) Pub. Date: Jun. 29, 2017

(54) CUP SET FOR DRIP COFFEE

(71) Applicant: Ik Hyun NAM, Seoul (KR)

(72) Inventor: Ik Hyun NAM, Seoul (KR)

(21) Appl. No.: 15/387,241

(22) Filed: Dec. 21, 2016

(30) Foreign Application Priority Data
Dec. 24, 2015 (KR) 10-2015-0186639

(51) Int. Cl. A47J 31/06; A47J 31/44

(52) U.S. Cl. CPC A47J 31/06; A47J 31/44

(57) ABSTRACT

A cup set for drip coffee is provided, in which enough water can be supplied for extracting coffee fluid, it is possible to extract strong coffee fluid by pouring water in a state of piling up coffee powder high, it is easy to use because a truncated cone-shaped funnel can be detached easily with one hand, and it does not have to be worried to spill coffee powder or brewed coffee. The cup set for drip coffee includes a cup having an opening formed at a top end, a lid formed with a groove, and formed with a first hole at a lower portion of the groove, a funnel configured to be received in an internal space of the cup and having a second hole at a lower portion for installing at the groove, and a filter installed in the funnel for filtering coffee remnants and extracting coffee fluid.

### FIELD OF TECHNOLOGY

The invention relates to improvements of a cup set for drip coffee, more specifically to a cup set for drip coffee enabling any user to easily extract and drink coffee fluid from ground coffee powder in a drip style.

### BACKGROUND OF TECHNOLOGY

One of extraction methods for brewed coffee is a drip-style extraction method, in which a filter is installed in a dripper, coffee powder is deposited, and hot water is added, so as to extract coffee fluid from the coffee powder.

For the flavor and fragrance, the drip-style brewed coffee is popular, but since it is difficult to carry around the dripper, inconveniently it can be enjoyed only in places with drippers.

As such, Korean Utility Patents 20-0280326 (Title of Invention: Disposable Extractor for Brewed Coffee, Inventor: Jae-Woong Park) and 20-0459398 (Title of Invention: Disposable Extraction Container for Brewed Coffee with Dripper, Inventor: Kwan-Pyo Shin) teaches such steps as installing a filter in a paper cup and the like and extracting the brewed coffee simply from coffee powder (referred as “prior arts” below).

However, in the teachings of the prior arts, a truncated cone-shaped funnel is disposed in the opening of cup, protruding much into the cup, so that in order to extract coffee fluid enough the cup must be made larger than necessary, which is a problem.

Also, in a case of making the cup smaller, the inner angle of the truncated cone-shaped funnel must be large, resulting in that the coffee powder is piled relatively low and therefore it is hard to extract strong coffee fluid.

Especially, in the first prior art, after extracting the coffee fluid, the cup must be held with a hand and the truncated cone-shaped funnel must be removed from the cup with the other hand, and therefore sometimes it is hard to unfasten fixing means on both sides with one hand only and the coffee remnants may be poured out unwillingly.

In the second prior art, the brewed coffee can be consumed as it is conveniently without removing the dripper, but since the user drinks coffee in a state of the dripper submerged in the coffee fluid, the coffee tastes less and some pollutants such as environmental hormone and the like may be introduced into the coffee fluid, and again the coffee remnants may be spilled.

### DETAILED DESCRIPTION OF INVENTION

### Technological Problems to Solve

An object of the invention is to provide a cup set for drip coffee, in which a user can enjoy the drip coffee easily, it can provide enough water for extracting coffee fluid, and it is possible to extract strong coffee fluid since coffee powder can be piled up high and then applied with water.

Another object of the invention is to provide a cup set for drip coffee, in which a truncated cone-shaped funnel cane be attached and detached easily with one hand only.

### Solution to Problems

A cup set for drip coffee according to the invention comprises: a cup having an opening formed at a top end; a lid installed at the top end of the cup detachably so as to enable the opening to be opened and closed, formed with a groove formed in a central portion so as to face a bottom of the cup with a cross-sectional area getting smaller and smaller as going downwards, and formed with a first hole at a lower portion of the groove connected with an inner space of the cup; a funnel configured to be received in an internal space of the cup and having a second hole at a lower portion for installing at the groove; and a filter installed in the funnel for filtering coffee remnants and extracting coffee fluid.

The filter may be attached along an inner surface of the funnel.

Preferably, a latching step is formed at a lower end portion of the funnel so as to protrude outwards at an edge of the second hole, to be inserted into the first hole, and to be latched at an edge of the first hole.

Preferably, each of the groove and the funnel has a shape of truncated cone and the each of the first hole and the second hole is circular.

Preferably, the latching step is formed by rolling a portion of the lower end of the funnel upwards and outwards.

In certain embodiments, the latching step is formed by extruding a portion of the lower end of the funnel outwards.

Coffee powder packaged hermetically may be disposed in the cup.

Sometimes, the filter has a shape of truncated cone container and the coffee powder may be packaged hermetically in a state of received in the filter.

Preferably, the filter may be received in the funnel and the funnel is sealed by vinyl.

Preferably, a third hole is formed at an edge of the lid and configured for enabling a user to drink coffee fluid extracted into the cup.

The coffee powder may be packaged and sealed in a tea bag made of filtering paper.

### Advantages of Invention

According to the invention, enough water can be supplied for extracting coffee fluid, it is possible to extract strong coffee fluid by pouring water in a state of piling up coffee powder high.

According to the invention, it is easy to use because a truncated cone-shaped funnel can be detached easily with one hand, and it does not have to be worried to spill coffee powder or brewed coffee.

Sometimes, since coffee powder is packaged and sealed in a truncated cone-shaped funnel, it is convenient to make and drink coffee.

### BRIEF DESCRIPTION OF DRAWINGS

FIG. 1 is a cross-sectional view showing an embodiment of a cup set for drip coffee according to the invention,

FIG. 2 is an exploded perspective view showing the cup set for drip coffee in FIG. 1,

FIG. 3 is a perspective view showing a state of usage of a cup set for drip coffee according to the invention,

FIG. 4 is a cross-sectional view for describing a state of installing a funnel in a groove of lid,

FIG. 5 is a cross-sectional view for showing a state that a latching step of funnel is latched at an edge of the first hole of lid,

FIG. 6 is a perspective view showing a state of packaging coffee powder in a filtering paper,

FIG. 7 is a perspective view showing a state of putting coffee powder packaged in the filtering paper in FIG. 6 and sealing.

### BEST MODES OF EMBODIMENTS OF INVENTION

Below, referring the attached figures, preferred embodiments of the invention are described in detail.

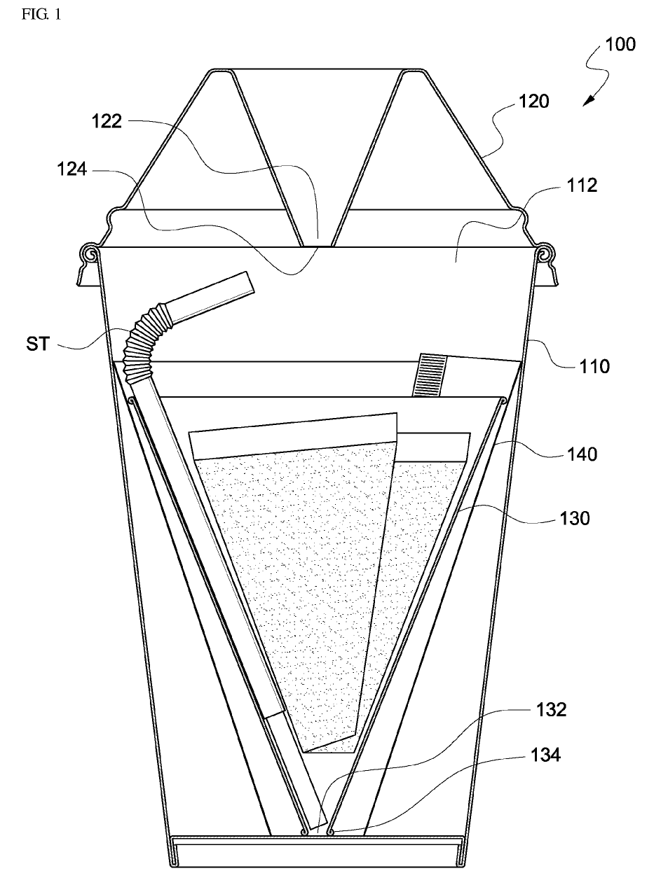

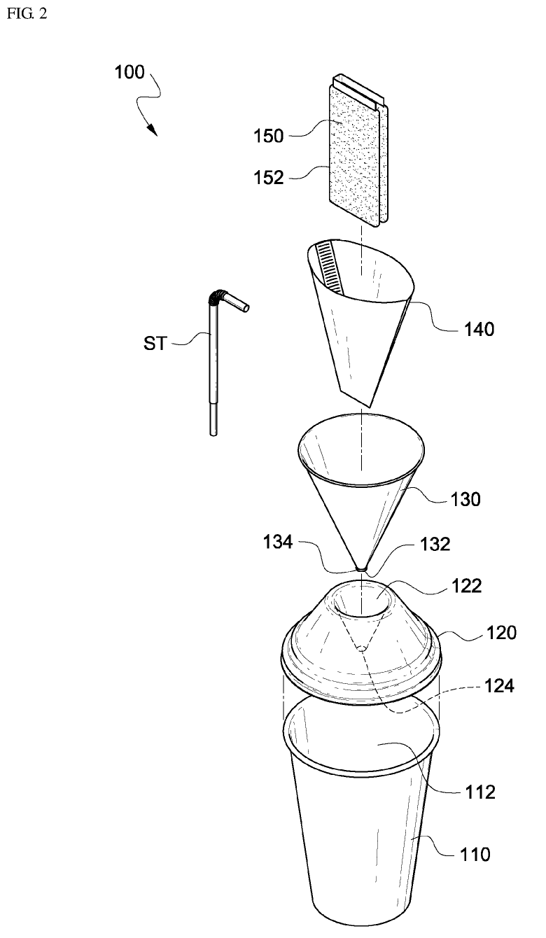

FIG. 1 is a cross-sectional view showing an embodiment of a cup set for drip coffee according to the invention, and FIG. 2 is an exploded perspective view showing the cup set for drip coffee in FIG. 1.

As shown in FIGS. 1 and 2, a cup set for drip coffee 100 according to the invention includes a cup 110. For the cup 110, a paper cup is preferable. Sometimes the cup 110 can be made with plastic. An opening 112 is formed at a top end of such cup 110.

The cup set for drip coffee 100 according to the invention includes a lid 120. The lid 120 is installed detachably at a top end of the cup 110, enabling to open and close the opening 112. In a central portion of the lid 120, a truncated cone-shaped groove 122 is formed, which is directed to the bottom of the cup set for drip coffee 100 and the cross-sectional area of which gets smaller and smaller as going downwards. In a lower end portion of the truncated cone-shaped groove 122 is formed a first hole 124 connected to the inside of the cup 110. Preferably, the first hole 124 is formed circular. Such truncated cone-shaped groove 122 is for installing a funnel 130 described later, which forms an inventive feature of the invention. At an edge of the lid 120 is formed a third hole, so that a user inserts a straw ST and the like to drink coffee fluid extracted into the cup 110.

The cup set for drip coffee 100 according to the invention includes the funnel 130. The funnel 130 must be able to be received in the cup 110. For example, in a case of using a 13 ounce capacity size for cup 110, it is appropriate to make the size of the funnel 130 of a 10 ounce capacity. At a lower end portion of the funnel 130 is formed a second hole 132. Preferably, the second hole 132 is formed circular. Such funnel 130 is configured to install a filter 140 along its inner surface, and has a shape of truncated cone with a little of apex removed.

At a lower end portion of such funnel 130 is formed a latching step 134, which protrudes outwards at an edge of the second hole 132. The latching step 134 is inserted into the first hole 124, and latched at an edge of the first hole 124, so that when water is applied after installing the filter 140 and filling coffee powder, the funnel 130 would not be shaken but maintain a stable installation state. Such latching step 134 is preferably formed by folding up a lower end portion of the funnel 130 outwards and upwards, making its external surface form a circular shape. Then, since a tilted surface is formed in a top side portion and bottom side portion of the latching step 134, it becomes easy to insert into or remove from the first hole 124, the bottom end of the funnel 130. The funnel 130 as shown in the above is preferably made of paper.

Sometimes, in a case of making the funnel 130 with plastic, the latching step 134 may be made in a shape formed by bending the bottom end portion of the funnel 130 outwards convexly. Of course, the same can be done in the case of the cup 110, which is made of paper.

A filter 140 is received in the cup 110, so as to be installed in the funnel 130, filter coffee remnants, and extract coffee fluid. For the filter 140, filtering papers in the market for drip coffee may be used.

Preferably, the coffee powder 150 is received in the cup 110 in a state that the coffee powder 150 is packaged through the wrapping paper 152. The coffee powder 150 is sealed with vinyl and the like, so as not to expose the coffee powder 150 to external air.

Sometimes, for the wrapping paper 152, a tea bag having a filtering function may be used, and in such a case the exterior of the tea bag is packaged once more with vinyl and the like, sealing inside from external air.

In a case of packaging the coffee powder 150 in a tea-bag style, the tea-bag-like package may be put in the filter 140 with the tea bag packaging intact, for extracting coffee fluid.

In the cup 110, a straw ST may be able to be received.

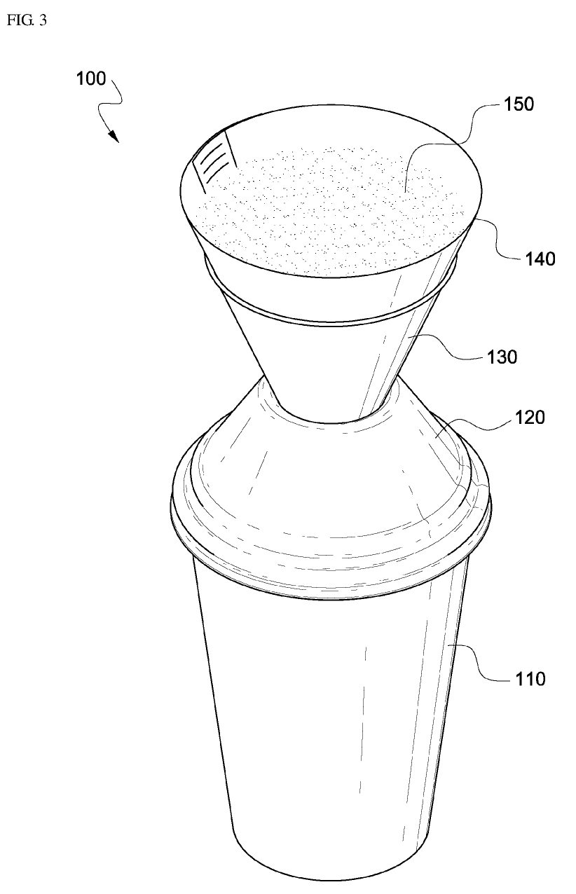

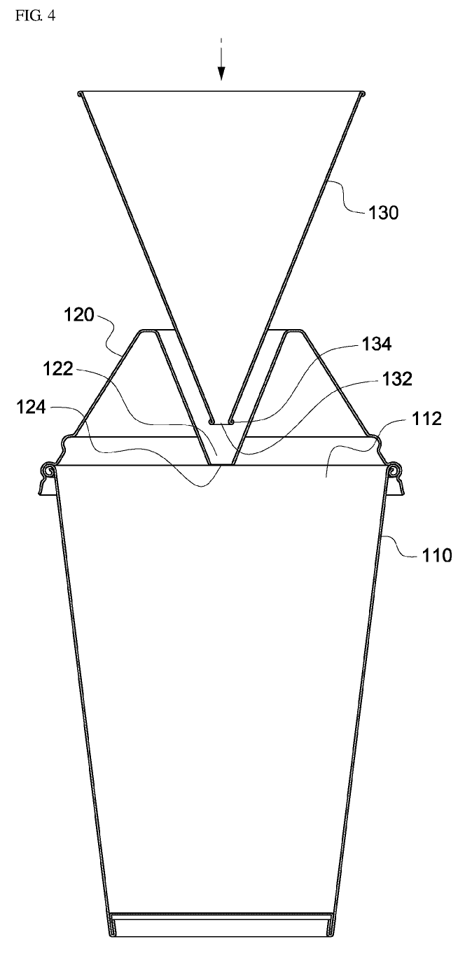

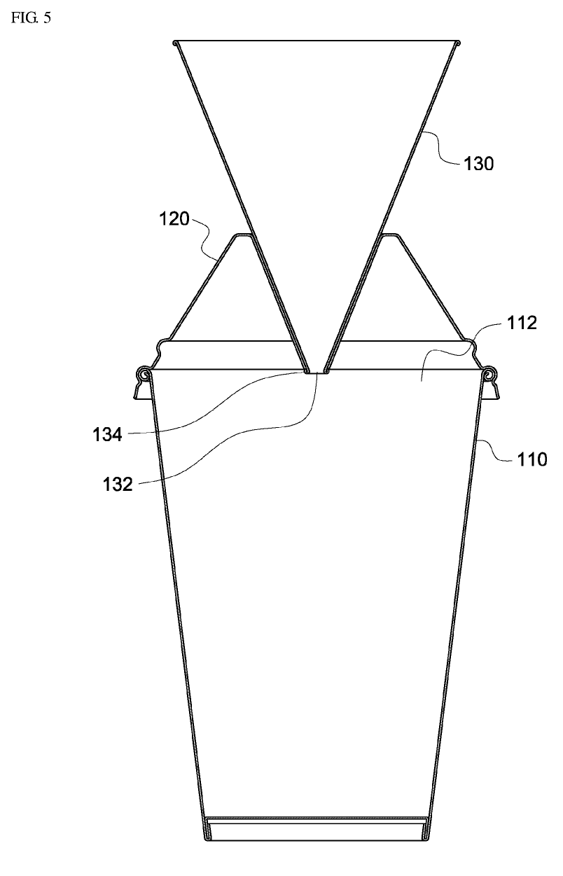

FIG. 3 is a perspective view showing a state of usage of a cup set for drip coffee according to the invention, FIG. 4 is a cross-sectional view for describing a state of installing a funnel in a groove of lid, and FIG. 5 is a cross-sectional view for showing a state that a latching step of funnel is latched at an edge of the first hole of lid.

Referring to FIGS. 1 and 2, how to use the cup set for drip coffee 100 according to the invention is going to be described.

In a case of using a cup set for drip coffee 100 described in FIGS. 1 and 2, the user opens the lid 120 and takes out the funnel 130 and others from the cup 110. Then, the user holds a top end portion of the funnel 130 and applies a little of force downwards as shown by an arrow in FIG. 4. Then, the latching step 134 contracts a little inwards, passes the first hole 124, and latches at an edge portion of the first hole 124 as shown in FIG. 5. Then, the funnel 130 is fixed to the lid 120, and then it won't be shaken even if water is poured after filling the coffee powder 150. Then, the filter 140 is folded in a shape of the funnel 130, installed in the funnel 130, and the user plucks out the packing of the coffee powder 150, fills the coffee powder 150 in the filter 140, and pours hot water to the coffee powder 150 filled in the filter 140. Then, the water passing the coffee powder 150 passes the filtering paper along with coffee components, and falls into the cup 110 through the first and second holes (124, 132).

If extracting of coffee fluid is done, the funnel 130 is removed from the truncated cone-shaped groove 122, and the user can drink the drip-style brewed coffee through the first hole 124 or by inserting a straw to a third hole that was bored at an edge of the lid 120. Sometimes, the user can drink the drip-style brewed coffee after opening the lid 120.

In a case of using the cup set 100 shown in the above according to the invention, enough amount of water for extracting coffee fluid can be supplied, and water can be poured on coffee powder piled up high, so as to extract strong coffee fluid for drinking.

Also, in the cup set for drip coffee 100 according to the invention, since the second hole 132 formed at a lower end portion of the funnel 130 is latched at an edge of the first hole 124 formed at a lower end portion of the truncated cone-shaped groove 122, the funnel 130 maintains a stable installation state, and since an interval between the latching steps 132 facing each other on both sides is very small and it is gathered around the lower end portion, the funnel 130 can be detached easily with a hand, which makes it easy to use and prevents coffee powder or extracted coffee fluid from spilling over.

### Embodiments of Invention

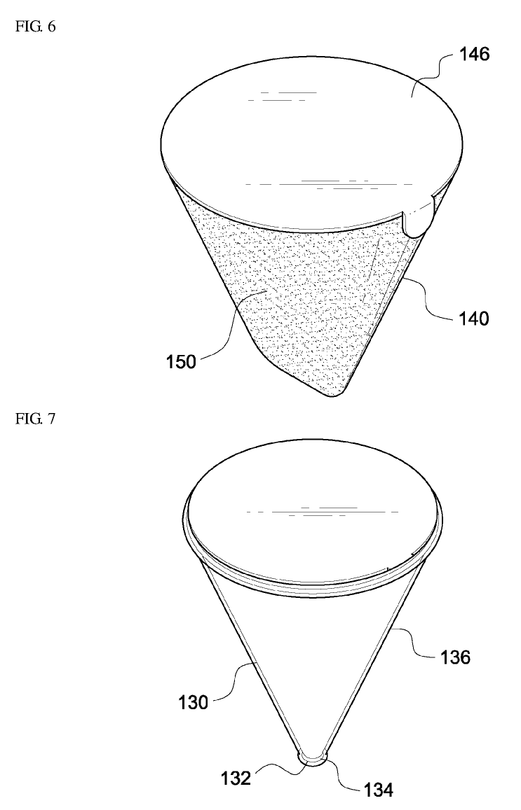

FIG. 6 is a perspective view showing a state of packaging coffee powder in a filtering paper, and FIG. 7 is a perspective view showing a state of putting coffee powder packaged in the filtering paper in FIG. 6 and sealing with vinyl and the like. They are described below referring to FIGS. 1 through 5, too.

Sometimes, as shown in FIG. 6, the filter 140 is made into a shape of truncated cone container, putting the coffee powder 150 there, blocking the opening with the paper cover 146, enclosing the funnel 130 with the vinyl 136, wrap, etc. or blocking the top and bottom openings and sealing as shown in FIG. 7. Then, since the drip coffee can be extracted by removing the vinyl 136 and the cover 146 only and in a state of the funnel 130 installed in the truncated cone-shaped groove 122, it is much more convenient. The top portion of the filter 140 is attached with the cover 146 in a folded state inwards, so as to spread after removing the cover 146 only.

The rest is same as what was described in the above.

### INDUSTRIAL APPLICATION

The invention may be used to manufacture cup set for drip coffee, which enables any one buys at a supermarket or convenience store and enjoy drip coffee.

1. A cup set for drip coffee comprising:
a cup having an opening formed at a top end;
a lid installed at the top end of the cup detachably so as to enable the opening to be opened and closed, formed with a groove formed in a central portion so as to face a bottom of the cup with a cross-sectional area getting smaller and smaller as going downwards, and formed with a first hole at a lower portion of the groove connected with an inner space of the cup;
a funnel configured to be received in an internal space of the cup and having a second hole at a lower portion for installing at the groove; and
a filter installed in the funnel for filtering coffee remnants and extracting coffee fluid.

2. The cup set for drip coffee of claim 1, wherein a latching step is formed at a lower end portion of the funnel so as to protrude outwards at an edge of the second hole, to be inserted into the first hole, and to be latched at an edge of the first hole.

3. The cup set for drip coffee of claim 2, wherein each of the groove and the funnel has a shape of truncated cone and the each of the first hole and the second hole is circular.

4. The cup set for drip coffee of claim 2, wherein the latching step is formed by rolling a portion of the lower end of the funnel upwards and outwards.

5. The cup set for drip coffee of claim 2, wherein the latching step is formed by extruding a portion of the lower end of the funnel outwards.

6. The cup set for drip coffee of claim 1, wherein coffee powder packaged hermetically is disposed in the cup.

7. The cup set for drip coffee of claim 2, wherein coffee powder packaged hermetically is disposed in the cup.

8. The cup set for drip coffee of claim 3, wherein coffee powder packaged hermetically is disposed in the cup.

9. The cup set for drip coffee of claim 4, wherein coffee powder packaged hermetically is disposed in the cup.

10. The cup set for drip coffee of claim 5, wherein coffee powder packaged hermetically is disposed in the cup.

11. The cup set for drip coffee of claim 3, wherein the filter has a shape of truncated cone container and the coffee powder is packaged hermetically in a state of received in the filter.

12. The cup set for drip coffee of claim 11, wherein the filter is received in the funnel and the funnel is sealed by vinyl.

13. The cup set for drip coffee of claim 1, wherein a third hole is formed at an edge of the lid and configured for enabling a user to drink coffee fluid extracted into the cup.

14. The cup set for drip coffee of claim 2, wherein a third hole is formed at an edge of the lid and configured for enabling a user to drink coffee fluid extracted into the cup.

15. The cup set for drip coffee of claim 3, wherein a third hole is formed at an edge of the lid and configured for enabling a user to drink coffee fluid extracted into the cup.

16. The cup set for drip coffee of claim 4, wherein a third hole is formed at an edge of the lid and configured for enabling a user to drink coffee fluid extracted into the cup.

17. The cup set for drip coffee of claim 5, wherein a third hole is formed at an edge of the lid and configured for enabling a user to drink coffee fluid extracted into the cup.

18. The cup set for drip coffee of claim 7, wherein a third hole is formed at an edge of the lid and configured for enabling a user to drink coffee fluid extracted into the cup.

19. The cup set for drip coffee of claim 8, wherein a third hole is formed at an edge of the lid and configured for enabling a user to drink coffee fluid extracted into the cup.

20. The cup set for drip coffee of claim 6, wherein the coffee powder is packaged and sealed in a tea bag made of filtering paper.
